(19) United States
(12) Patent Application Publication
(10) Pub. No.: US 2019/0077623 A1
(43) Pub. Date: Mar. 14, 2019

(54) PORTABLE WALL BASE COIL UNWINDING DEVICE

(71) Applicant: David W. Low, Centralia, WA (US)

(72) Inventor: David W. Low, Centralia, WA (US)

(21) Appl. No.: 15/700,851

(22) Filed: Sep. 11, 2017

(51) Int. Cl. B65H 16/02; E04F 21/00; B62B 3/04; B62B 3/10; B62B 3/12

(52) U.S. Cl. CPC B65H 16/028; E04F 21/0053; B62B 3/04; B62B 2203/071; B62B 3/12; B62B 2202/025; B62B 2301/04; B62B 3/104

(57) ABSTRACT

A portable wall base coil unwinding device is disclosed herein that comprises a base caddy having a topside and a bottom side; a turntable positioned above the topside of the base caddy; a lazy Susan swivel connector rotatably connecting the base caddy to the turntable; a wall base coil holder centrally positioned on the turntable, wherein the wall base coil holder is sized and configured to receive and retain a coil of wall base; and at least three freely rotatable and swivable wheels positioned on the bottom side of the base caddy. The present invention provides an improved tool and method for unwinding and positioning/installing a wall cove base material along the base of a wall.

### TECHNICAL FIELD

The present invention relates generally to building construction interior finish work and, more specifically, to a portable device for facilitating the unwinding of coils of wall cove base (also known simply as “wall base”) on-site thereby easing its positioning and installation along the base of a wall.

### BACKGROUND OF THE INVENTION

As is appreciated by those in the building construction industry, wall cove base (also known simply known as “wall base” and sometimes referred to as “rope cove base” or “mop board”) is a type of resilient and flexible trim (molding) that is installed along the base of an interior wall where the wall meets the floor. Wall cove base is generally made of vinyl or rubber and is used to protect the base of a wall from damage and to provide a finished and more aesthetically pleasing look where it is installed. Vinyl and rubber molding is often selected over traditional wood baseboards because it is typically less expensive and is generally easier to install.

Wall cove base is manufactured in a variety of colors to match most interior color schemes. Wall cove base is typically sold in rolls (e.g., 4-inch or 6-inch rolls (coils)) of differing lengths (up to 120 feet) that can weigh up to 70 lbs. The installation of wall cove base along the base of a wall is very labor intensive. The coil of wall cove base must first be unwound to the desired length and cut, a special adhesive must then be applied (to the backside of the wall cove base) before it is pressed onto the wall (by a worker crawling along the floor on his/her hands and knees). In the trade, there are two known manual methods for positioning/installing wall cove base along the base of a wall: one method involves an installer walking backwards bent over while unrolling a roll of wall cove base, and the other method involves an installer laying a roll of wall cove base on its side and then throwing (rolling) the roll forward as the installer positions and installs the wall cove base onto the wall.

Because the positioning and installing wall cove base along the base of a wall is very labor intensive, there is still a need in the art for new and improved tools and methods for unwinding and positioning/installing a wall cove base material along the base of a wall. The present invention fulfills this need and provides for further related advantages.

### SUMMARY OF THE INVENTION

In brief, the present invention is directed to a portable wall base coil unwinding device that comprises a base caddy having a topside and a bottom side; a turntable positioned above the topside of the base caddy; a lazy Susan swivel connector rotatably connecting the base caddy to the turntable; a wall base coil holder centrally positioned on the turntable, wherein the wall base coil holder is sized and configured to receive and retain a coil of wall base; and at least three wheels positioned on the bottom side of the base caddy. The base caddy, the turntable, and the wall base coil holder are all preferably made out a rigid sheet material such as, for example, plastic or plywood. The lazy Susan swivel connector is preferably comprised of a plurality of ball bearings positioned between a pair of opposing metal plates. The at least three wheels are preferably caster wheels that can each freely swivel about a vertical axis and freely rotate about a horizontal axis. A tow rope connected to the base caddy is provided to facilitate the towing/moving the portable wall base coil unwinding device along the floor.

These and other aspects of the present invention will become more readily apparent to those possessing ordinary skill in the art when reference is made to the following detailed description in conjunction with the accompanying drawings.

### BRIEF DESCRIPTION OF THE DRAWINGS

The drawings are intended to be illustrative of certain preferred embodiments of the present invention. Like reference numerals have been used to designate like features throughout the several views of the drawings.

FIG. 1 is an elevated perspective view of a portable wall base coil unwinding device in accordance with an embodiment of the present invention.

FIG. 2 is a side view of the portable wall base coil unwinding device shown in FIG. 1.

FIG. 3 is a top plan view of the portable wall base coil unwinding device shown in FIGS. 1 and 2.

FIG. 4 is an elevated exploded view of the portable wall base coil unwinding device shown in FIG. 1-3.

FIG. 5 is an elevated perspective view of a portable wall base coil unwinding device having a partially unwound roll of wall base coil positioned thereon in accordance with an embodiment of the present invention.

### DETAILED DESCRIPTION OF THE INVENTION

In the following detailed description, reference is made to the accompanying drawings, which form a part hereof. In the drawings, similar symbols or markings have been used to identify like or corresponding elements, unless context dictates otherwise. The illustrative embodiments described in the detailed description, drawings, and claims are not meant to be limiting. Other embodiments may be utilized, and other changes may be made, without departing from the spirit or scope of the subject matter presented herein.

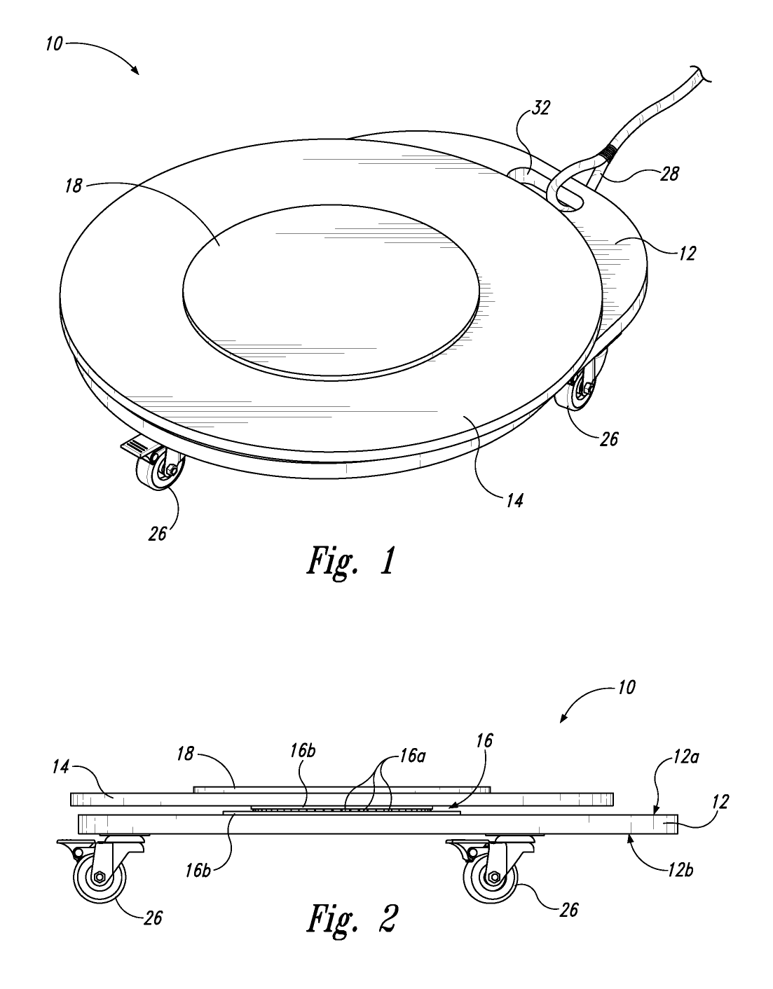

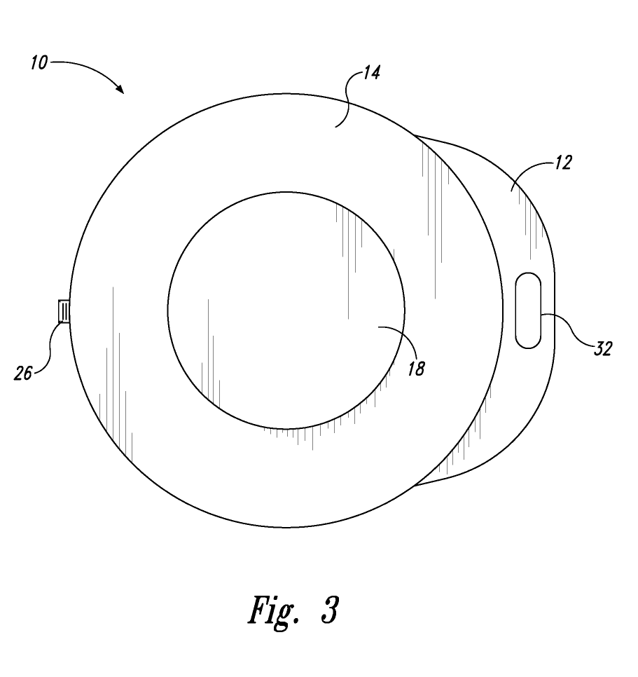

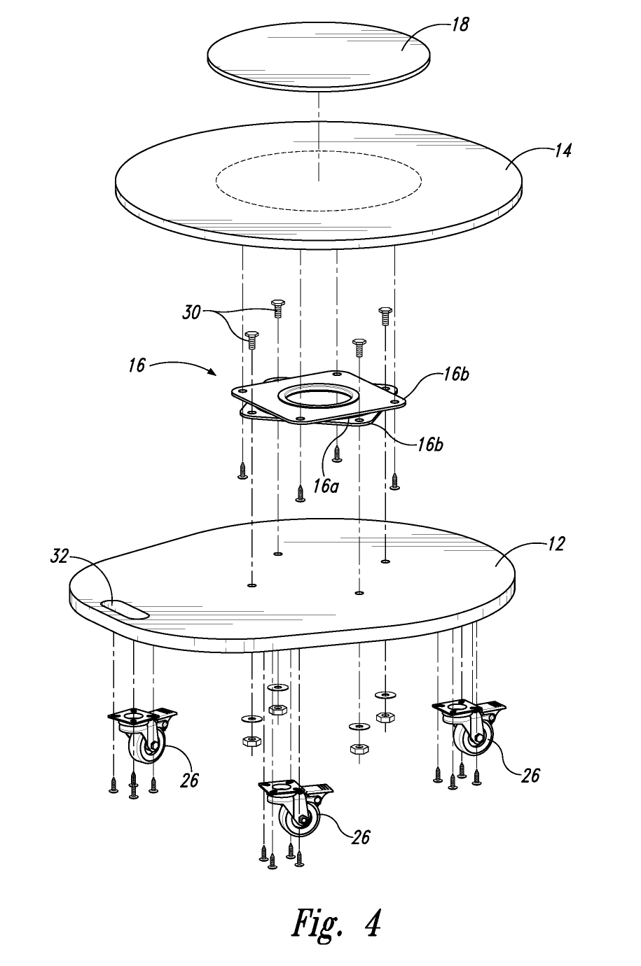

Accordingly, and in view of the foregoing and referring now to the drawings, and more particularly to FIGS. 1-5, the present invention is directed to a portable wall base coil unwinding device 10 useful for unwinding and installing rolls of wall cove base along the base of a wall. As shown, the inventive portable wall base coil unwinding device 10 comprises a base caddy 12 that has a topside 12a and a bottom side 12b. The base caddy 12 is preferably made out a rigid sheet material (such as, for example, a hard plastic material or ½ inch plywood) that has been shaped or cut (as the case may be) into an oblong shape as shown (preferably having long and short crosswise diameters of about 26 inches and 20 ⅞ inches, respectively). As shown, a turntable 14 is positioned above the topside 12a of the base caddy 12. The turntable 14 is also preferably made out a rigid sheet material (such as, for example, a hard plastic material or ¼ inch plywood) that has been shaped or cut (as the case may be) into a circular shape as shown (preferably having a diameter of about 22 inches).

As further shown, a lazy Susan swivel connector 16 has been provided to rotatably interconnect the base caddy 12 to the turntable 14. The lazy Susan swivel connector 16 is preferably comprised of a plurality of ball bearings 16a positioned between a pair of opposing square metal plates 16b (that are each preferably about 6×6 inches in dimension). The opposing square metal plates 16b are attached to the topside 12a of the base caddy 12 and the bottom side of the turntable 14 by means of fasteners (such as, for example, a plurality of standard wood screws 30). In this configuration, the turntable 14 is freely rotatable.

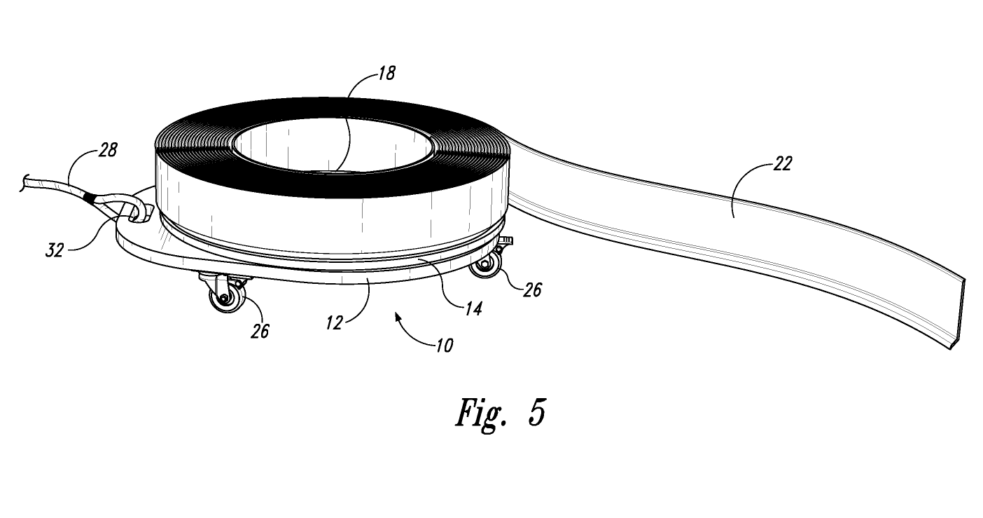

As still further shown, a centrally positioned wall base coil holder 18 has been provided on the turntable 14, wherein the wall base coil holder 18 has been sized and configured to receive and retain a coil of wall base 22 (as best shown in FIG. 5). The turntable 14 is also preferably made out a rigid sheet material (such as, for example, a hard plastic material or 1 inch plywood) that has been shaped or cut (as the case may be) into a circular shape as shown (and preferably having a diameter of about 11 ¾ inches). The wall base coil holder 18 is preferably attached to the turntable 14 be means of an adhesive or wood glue (not shown).

The inventive portable wall base coil unwinding device 10 also comprises least three wheels 26 positioned (spaced apart) on the bottom side 12b of the base caddy 12. The at least three wheels 26 are preferably 1 ½ inch caster wheels (with optional brake tabs) that can each swivel about a vertical axis and rotate about a horizontal axis. In other words, the at least three wheels 26 are preferably freely rotatable and swivable. As shown, the at least three wheels 26 are preferably attached to the bottom side 12b of the base caddy 12 by means of fasteners (such as, for example, a plurality of screws 30).

In order to facilitate the towing/moving of the inventive portable wall base coil unwinding device 10 along the floor, a tow rope 28 of a desired length may be connected to the base caddy 12. And in order to facilitate the carrying of the inventive portable wall base coil unwinding device 10, a slot 32 (that is preferably about 4 inches by about 1 ¼ inches) may be cut into one end of the base caddy 12 as shown.

In other aspect, the present invention provides an improved tool and method for unwinding and positioning/installing a wall cove base material along the base of a wall. The inventive method comprises at the least the steps of: providing a portable wall base coil unwinding device as disclosed herein; positioning a coil of wall base onto the wall base coil holder that is centrally positioned on the turntable; and unwinding the coil of wall base while moving the portable wall base coil unwinder device along the floor and base of the wall.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing descriptions, and all changes that come within the meaning and range of equivalency of the claims are to be embraced within their scope.

What is claimed is:

1. A portable wall base coil unwinding device, comprising:
a base caddy having a topside and a bottom side;
a turntable positioned above the topside of the base caddy;
a lazy Susan swivel connector rotatably connecting the base caddy to the turntable;
a wall base coil holder centrally positioned on the turntable, wherein the wall base coil holder is sized and configured to receive and retain a coil of wall base; and
at least three wheels positioned on the bottom side of the base caddy.

2. The portable wall base coil unwinding device of claim 1 wherein the base caddy is made from a rigid sheet material.

3. The portable wall base coil unwinding device of claim 2 wherein the turntable is made from a rigid sheet material.

4. The portable wall base coil unwinding device of claim 3 wherein the wall base coil holder is made from a rigid sheet material.

5. The portable wall base coil unwinding device of claim 1 wherein the lazy Susan swivel connector is comprised of a plurality of ball bearings positioned between a pair of opposing metal plates.

6. The portable wall base coil unwinding device of claim 5 wherein the at least three wheels are caster wheels that can each swivel about a vertical axis and rotate about a horizontal axis.

7. The portable wall base coil unwinding device of claim 6, further comprising a tow rope connected to the base caddy.
